(19) United States
(12) Patent Application Publication
(10) Pub. No.: US 2003/0013071 A1
(43) Pub. Date: Jan. 16, 2003

(54) Computerized exercise apparatus

(76) Inventor: Richard Todd Thomas, Novato, CA (US)

Correspondence Address: FLIESLER DUBB MEYER & LOVEJOY, LLP, FOUR EMBARCADERO CENTER, SUITE 400, SAN FRANCISCO, CA, 94111, US

(21) Appl. No.: 09/898,834

(22) Filed: Jul. 3, 2001

(51) Int. Cl. G09B 9/00; G09B 19/00; A63B 69/00

(52) U.S. Cl. 434/247

(57) ABSTRACT

A computerized and possibly distributed resistance training system includes at least one training station having an adjustable and configurable training mechanism. The training mechanism is arranged to enable a user to perform repetitions of an exercising or training motion. The training mechanism includes an adjustment mechanism, which is responsive to a computer. The adjustment mechanism is further operatively coupled to the resistance training mechanism to effect an automatic adjusting and configuring of the mechanism upon an identifying of a respective user.

### BACKGROUND OF THE INVENTION

1. Field of the Invention

The present invention relates to exercise and athletic training machines. More particularly, the present invention relates to computer controlled training apparatus providing fully automated adjustment and configuration at the time of use.

2. Background and Objects of the Invention

A large variety of exercise and conditioning apparatus are known in the art. These machines may range from a single exercise device, such as a elliptical trainer or a bench-press machine, to a multi-station apparatus having a plurality of what may be termed ‘training stations’.

When considering training facilities having a number of varied training apparatus, each time an individual moves from one training station to a next, a number of adjustments and settings must be effected. For example, a desired resistance level or an amount of weight to be lifted must be selected. In addition, other physical adjustments or physical parameter settings must typically be applied, including one or more of adjusting seat backs, bench heights, spacings of hand gripping portion or locations, etc. As such, the proper adjusting and configuring of a training station can be time consuming and tedious. For example, if a number of training stations are to be used, the proper adjusting and configuring of each station, may account for an appreciable amount of available time, especially when one is attempting to fit a training session into a relatively short period of time before or after a work day. However, it is essential that such training apparatus be properly adjusted to accommodate the individual using the apparatus to prevent a possible serious injury, as well as maximize the results and gain of a training or workout session.

When considering an individual that has developed and maintains a complicated training routine, it is often necessary to record the various settings and resistance levels applied to each training station, for each training session. This adds an additional burden and further increases the time period required to complete a training session. In addition, if the recorded information describing the training sessions is lost or misplaced, an individual would have to invest a significant effort to re-create and re-record the information.

Therefore, skilled individuals will recognize a need for improved and automated training apparatus. In particular, an automated and computer controlled apparatus would be most desirable wherein a user is first identified, and as a result a plurality of settings and adjustments may be automatically effected. Further, such a computer based system would enable the monitoring of training sessions and the progress of users thereof. Therefore, such a system enables an automatic adjusting of resistance levels dynamically during a training session, or on a session by session basis.

A full understanding of the present invention, including an understanding of a number of capabilities, characteristics, and associated novel features, will result from a careful review of the description and figures of several preferred embodiments provided herein. Attention is called to the fact, however, that the drawings and descriptions are illustrative only. Variations and alternate embodiments are certainly contemplated as being part of the invention, limited only by the scope of the appended claims.

### SUMMARY OF THE INVENTION

In accordance with the present invention a computerized resistance training apparatus is structured with a resistance training mechanism. The resistance training mechanism is arranged to enable a user to perform training repetitions of an exercising or training motion. The training repetitions, which are useful for conditioning one or more muscles of the body of a user, may range from steps on a treadmill, to basic lifting motions, to a variety of ‘crunching’ motions, with each motion being at least partially made against an established level of resistance.

The training apparatus further includes a computer, which is preferably provided by a microprocessor or microcontroller based embedded system, along with an adjustment mechanism. The adjustment mechanism is responsive to the computer, and is further operatively coupled to portions of the resistance training mechanism. This operative coupling enables an adjusting and configuring of one or more physical parameters of the resistance training apparatus by applying one or more preferably personalized settings associated with a user. For example, a resistance level may be set, a seat back may be adjusted, the height of a grasping bar (above from a ground surface) may be altered, a pedal distance may be changed, etc. Regardless of the particular structure and training motions supported by a respective training apparatus or a station thereof, one or more physical parameters, along with a resistance level, will typically require adjusting and configuring.

An important initial step carried out with the present invention includes an identifying of the user who is about to use a respective training station or apparatus. Accordingly, each embodiment of the invention would include a means to enable a user commencing activities upon a resistance training apparatus to be identified and possibly authorized. Such an identification may be realized by way of a magnetic card reader, a radio frequency ID device, a bio-reading means, inputting an identification number, or any suitable means that would enable the user to be easily, accurately, and rapidly identified prior to commencing activities upon a training apparatus. Subsequently, after a user is identified, an authorizing of the user may be included to possibly block an individual from using a respective automated training apparatus or station of the invention. For example, in a commercial gymnasium or health club environment a user may be required to receive some instruction or an evaluation before using a more complicated or demanding apparatus.

The invention would also includes a means for recalling at least one personalized setting, which has been previously determined for the user, that may be applied for adjusting and configuring a resistance training apparatus upon an identifying of the user. This latter means may include the adjustment mechanism, along with any interface components necessary to enable the computer to be in operative communication with the adjustment mechanism.

Therefore, embodiments of the training apparatus' of the invention are structured for automatically adjusting and configuring various physical parameters to selected settings and values specifically associated with an identified user. These settings would typically result in adjusting dimensions, configurations, resistance levels, etc., of one or more portions of a resistance training mechanism. It may be noted that a change in configuration may also completely alter the type of training activity or exercise that can be performed upon the training apparatus.

As will be appreciated by skilled persons, adjustments to physical parameters are realized by actuating one or more adjusting means of an adjustment mechanism. The adjusting means, which may also be termed actuators, are contemplated to include one or more of solenoids, relays, linear actuators, motors, motorized pinions, and or other known means available to those skilled in the art. Each of these devices may be electrically, hydraulically, or pneumatically actuated or energized.

An alternate embodiment of the invention may be provided in the form of distributed, computerized, and automated resistance training system. Such a system may be configured having a plurality of resistance training stations, with each structured for enabling a user to perform thereupon repetitions of a respective resistance training activity. As with the first embodiment of the invention, each training station is structured with a resistance training mechanism in operative communication with a computer for enabling adjusting and configuring of portions of the training mechanism for use by a respective user. In addition, each resistance training station includes means for enabling personalized settings to be applied to adjust and configure the station for use by an identified user. Such a means may most preferably include a database and a database management system.

A training system having a distributed architecture would couple each resistance training station to a remote computing means via suitable hardwired or wireless communication links. User information, including all personalized settings for each training station, may then be centrally located and administered. This arrangement would also enable a user to select and use any one of a plurality of identical training stations that are available, and have appropriate settings quickly downloaded and applied.

### BRIEF DESCRIPTION OF THE DRAWINGS

In the drawings, like elements are assigned like reference numerals. It is important to note that each of the embodiments of the invention depicted are but one of a number of possible arrangements utilizing the fundamental concepts of the present invention. The drawings are briefly described as follows:

FIG. 1 provides a high-level block diagram of an embodiment of a resistance training apparatus in accordance with the present invention.

FIG. 2 presents a simplified flow-chart of an embodiment of a method employable with the apparatus of FIG. 1.

FIG. 3 is a high-level block diagram of another embodiment of the present invention having a distributed and preferably networked architecture.

FIG. 4 provides a simplified top-level flow-chart of an embodiment of a method employable with the distributed architecture of FIG. 3

FIGS. 5A and 5B each depict database records available for recalling and applying to adjust and configure a respective training station and or apparatus of the invention.

PARTIAL LIST OF REFERENCE NUMERALS

| | |
|---|---|
| 10 | resistance training apparatus |
| 12 | (distributed) resistance training system |
| 14 | training mechanism |
| 16 | adjustment mechanism |
| 20 | computer, computer module, or computing means |
| 22 | remote (separate) computer |
| 24 | resistance training station |
| 30 | human interface module |
| 30a | display unit |
| 30b | audio unit |
| 30c | user input hardware |
| 38 | communication network or link |

### DETAILED DESCRIPTION OF THE PREFERRED EMBODIMENTS

It is important to establish definitions for a number of terms and expressions that are used throughout this disclosure. The term ‘resistance level’, as applied in the context of the present invention, is to be defined broadly. As such, a resistance level is to be defined as a resistance or force that is applied against a training motion or training activity to increase a level of exertion required by a user. An increase in resistance or resistance level may involve an increase in weights to be lifted, or equivalently, an increase in friction or required torque associated with a training motion. The term ‘physical parameter’ may be assumed to include any physical or configuration setting associated with a respective training station or apparatus. Accordingly, a physical parameter setting may include a seat back position setting, a bench height setting, a position setting of at least one hand or foot contacting portion, etc. It may be noted that a resistance level adjustment is to be considered as an additional item to be applied in addition to any required physical parameter settings. The term ‘resistance training activity’ is to include a wide variety of training and conditioning activities that may be effected upon a training station of the invention. These would include activities such as running, biking, rowing, stair climbing, weight lifting, and a wide variety of other known exercise, training and workout activities and motions. As such, a resistance training activity will often involve repetitions of ‘training motions’—with a completion of each full motion being termed a ‘repetition’ or rep. Additional terms and their associated meanings will be provided as needed.

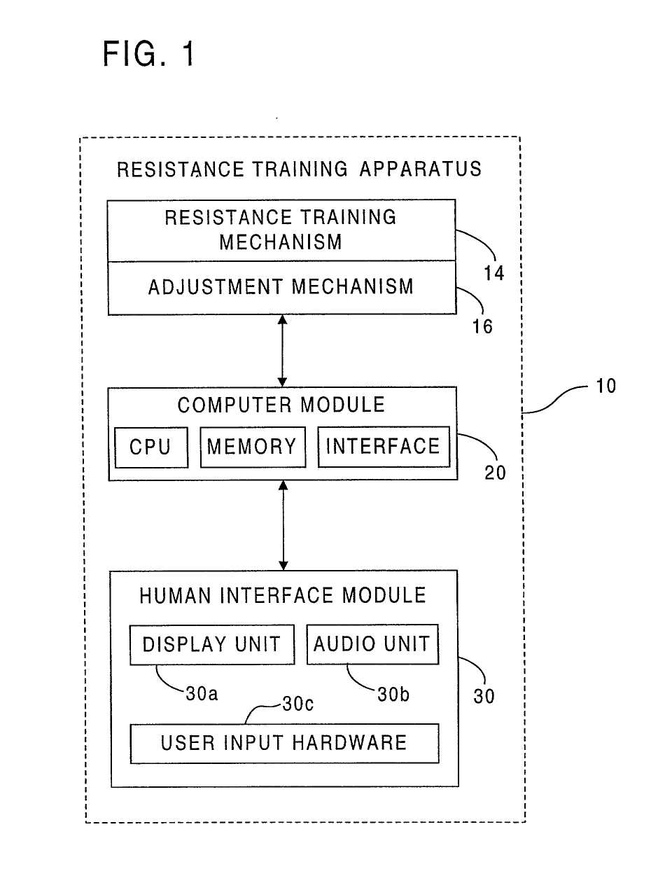

Referring now to FIG. 1, there is provided a high-level block diagram of a computerized resistance training apparatus 10 in accordance with the present invention. As depicted, a resistance training mechanism 14 is operatively coupled to an adjustment mechanism 16. The training mechanism 14 is specifically structured for enabling a user to perform repetitions of an exercising or training motion. Each training motion will generally have associated therewith at least one selectable resistance level that is selected to establish a desired level of resistance. For example, an amount of weights to be lifted or a friction setting may be adjusted. The adjustment mechanism 16 includes means for adjusting physical parameters of the training apparatus 10. Any settings applied to alter the physical parameters are preferably previously determined and stored in a suitable database. When applied in accordance with the invention, the settings may certainly cause an adjusting of one or more user contacting portions of the resistance training mechanism 14 so as to accommodate physical attributes of a user preparing to use the apparatus 10.

When considering the embodiment of FIG. 1, a database may be provided by a computer or computing means of computer module 20. Alternately, the embodiment of FIG. 1 may employ an interface of computer module 20 to enable communication with another remote or discrete computer, with the remote computer including the database of user information from which settings are download. The downloaded settings would then be applied by computer module 20.

To support an automated adjusting and configuring of one or more physical parameters of the apparatus 10, the adjustment mechanism 16 is operatively coupled to, and responsive to, a computer such as computing module 20. The computer is further coupled to a human interface 30. The human interface 30 is contemplated to include a user input hardware 30c. The user input hardware 30c is provided to enable a user to input information, including information enabling the apparatus to identify the user and access one or more stored data records associated with the user and a selected training apparatus 10.

As shown in FIG. 1, a display unit 30a and an audio unit 30b may be included to enable an exchanging of information between the user and the apparatus, as required before commencing and completing a training activity. For example, information related to a repetition count setting, a number of repetitions completed or remaining, a resistance level setting, etc., may be delivered by the display unit 30a.

When considering portions of the training apparatus 10 that enable a user to be identified, a plurality of varied structures and approaches may be utilized. For example, simple keypads and user PINs may be used. Equivalently, magnetic card readers, bio-scanning devices, or RF-ID technology may be employed. Regardless of the particular structure and components actually utilized, such portions of the present invention may be generically termed “means to enable a user to be identified”. Such a means may actually employ an exchange between the computing module 20 and other devices or modules for a user identification to be fully realized. Similarly, a combination of portions of the computing module 20, the human interface module 30 and the adjustment mechanism 16 may be termed a “means for enabling at least one personalized setting to be recalled and applied for configuring the resistance training apparatus”. Most preferably, the personalized settings were previously determined, and are applied upon an identifying of the user, and possibly subsequently updated as desired.

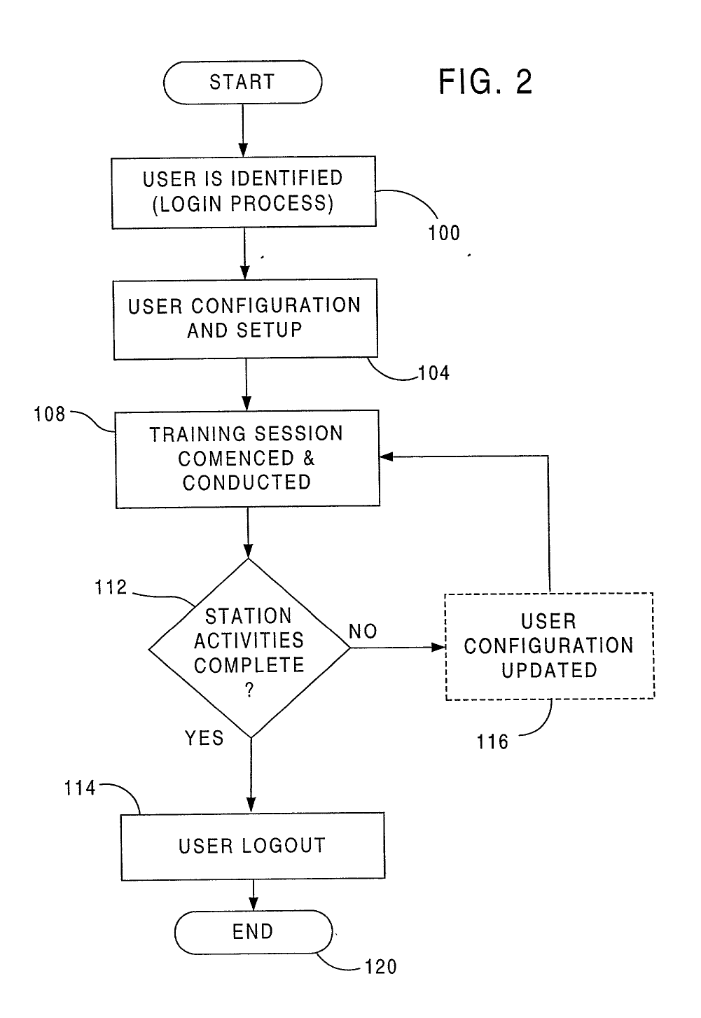

Turning now to FIG. 2, a simplified flow-chart is provided for an embodiment of a method of the invention that is employable with the apparatus of FIG. 1, and equivalents thereto. The method may most preferably commence with a user being identified. The identifying may be by way of a ‘login’ event. For example, the user may be required to input a unique string of characters and possibly a personal identification number (PIN). Once identified at 100, a training apparatus 10 may be automatically configured, adjusted, and setup at 104 for use by the identified user. At 108, a workout or training session is commenced and conducted-resulting in the user performing repetitions of a training activity. At 112, the algorithm may call for an iterative evaluation as to whether all desired or required activities to be conducted upon the present training apparatus 10 have been completed. If so, the user preferably logs out, and possibly moves to another training station, progressing through an established training routine. If activities at a present training station have not been completed, at 116 additional adjusting and configuring may be performed upon the training apparatus 10, and additional exercising or training session activities are conducted. It may be noted that the additional training session may not require any additional adjusting and configuring, which is indicated by step 116 being provided with a dotted outline.

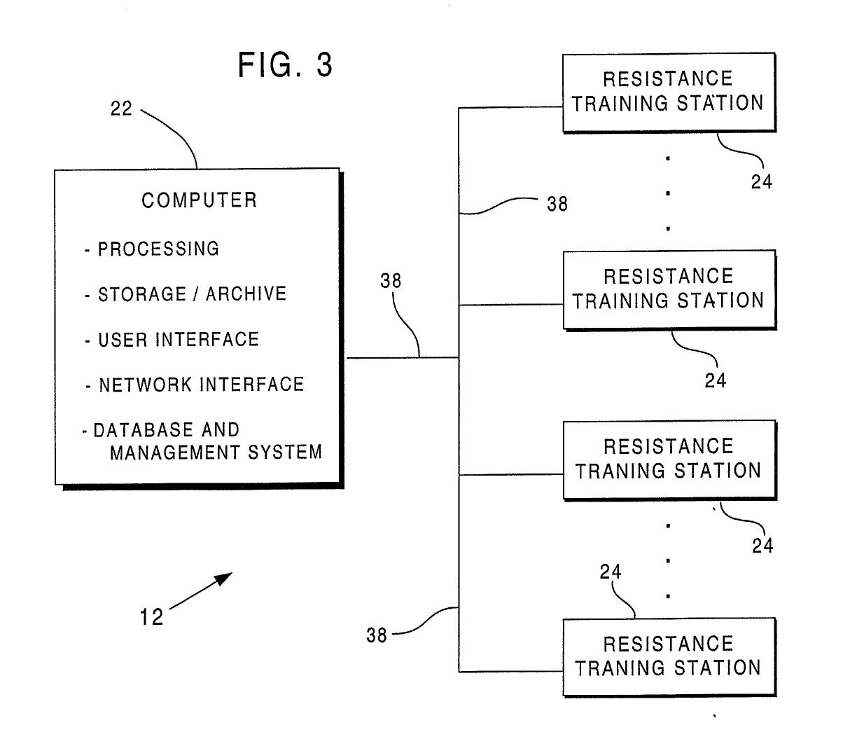

Referring now to FIG. 3, a high-level block diagram is provided depicting another possible embodiment of the invention. As can be seen therein, a training system 12 is provided that may be termed a distributed, computerized, and automated resistance training system. The system 12 includes a plurality of configurable resistance training stations 24 and at least one possibly remote and or discrete computer 22, which is in operative communication with each training station 24. For example, a communication network 38 may be employed to interconnect the computer 22 to each of the resistance training stations 24.

Each training station 24 of the embodiment of FIG. 3 is structured with a resistance training mechanism 16 in operative communication with a computer, enabling an adjusting and configuring of a resistance training mechanism 16 as required to accommodate a respective user. It must be understood that computer 22 may actually exchange information with an embedded computing means provided with each resistance training station 24. Accordingly, the training apparatus 10 of FIG. 1, or variations thereof, may be adapted to function as training stations 24. As discussed above, the actual adjusting and configuring of a respective training station 24 begins upon or shortly after an identifying of a user about to use a training station 24. As such, each resistance training station 24 is preferably structured with a means enabling personalized settings to be applied to adjust and configure one or more physical parameters of the station for use by the user.

In a preferred embodiment of the training system 12, the computer 22 would include and or have access to a database management system. The computer 22 may be remote or distanced from the training stations 24, yielding a truly modular and expandable embodiment. Alternately, a multi-station arrangement having a plurality of structurally connected training stations 24 may include a computer 22 provided within a suitable portion of such an embodiment.

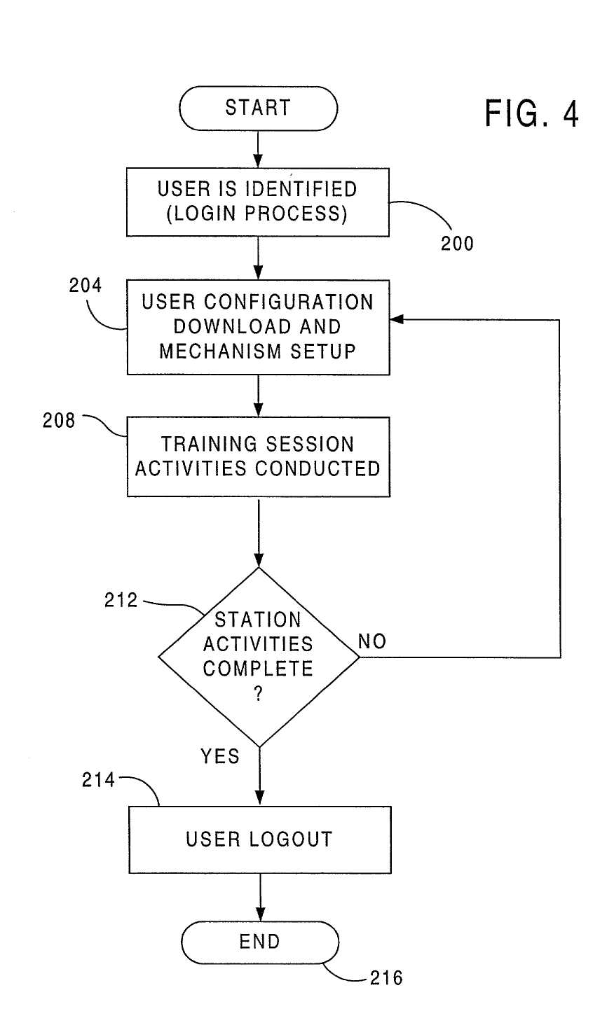

A method that may be employed with the architecture of FIG. 3 is depicted by the flow-chart of FIG. 4. As shown, at 200 a user is identified at a respective training station 24. This may involve a login process, wherein the user provides a user name, or ID number, possibly followed by a password or identification number. Once a user is identified at 200, at 204 it is contemplated that one or more records may be automatically accessed for downloading from an available database. The records including one or more personalized settings, a resistance level setting, and other possible information, each of which may be recalled and downloaded to the resistance training station 24. The downloaded information is then applied to adjust and configure a training station 24.

At 208, a training session is conducted with the user performing training activities via the training station 24. At 212, a determination is made as to whether activities of the user on the present training apparatus are complete. If not, additional information may be downloaded and applied to adjust and configure mechanisms of the apparatus at 204, and additional training activities may be conducted at 208. If no additional training activities are required, the user ends the session at the present training station 24. As can be seen at 214, an ending of activities may involve a ‘logging out’ or logout process to be executed.

It must be understood that the method of FIG. 4 is one of a number of methods that may be employed with the present invention. For example, a login process at 200, may simply involve a magnetic card being inserted into a suitable magnetic card reading device of the training station 24. Further, upon identification a user may use the human interface 30 to select one or more optional settings and adjustments, thereby enabling a user to further define, customize, or alter settings to be used for that training session. Most preferably, such additional settings and adjustments may be defined once and stored for future use, as desired. If a user has not used a respective apparatus or station before, an initial use may require selecting, inputting, or more generally providing of information to the training system 12 to be stored in a database for future use of that apparatus.

It must be further understood that the method of the flow chart of FIG. 4 may certainly include additional steps. For example, one such additional step may be added to the flow chart of FIG. 4 between 212 and 214. After a training activity being conducted upon a training station 24 is complete, the system 12 and training stations thereof may be arranged to upload (to the computer 22), altered and updated personalized settings, which are preferably stored in the database for future use. The altering and updating of one or more settings may be the result of one or more of: 1) completing a pre-determined number of repetitions of a given training activity, 2) a number of retrievals of personalized settings from the remote database, 3) user adjustments associated with previous user performed station activities, and 4) calculations based on previously stored personalized settings, along with information associated with previous user performed station activities.

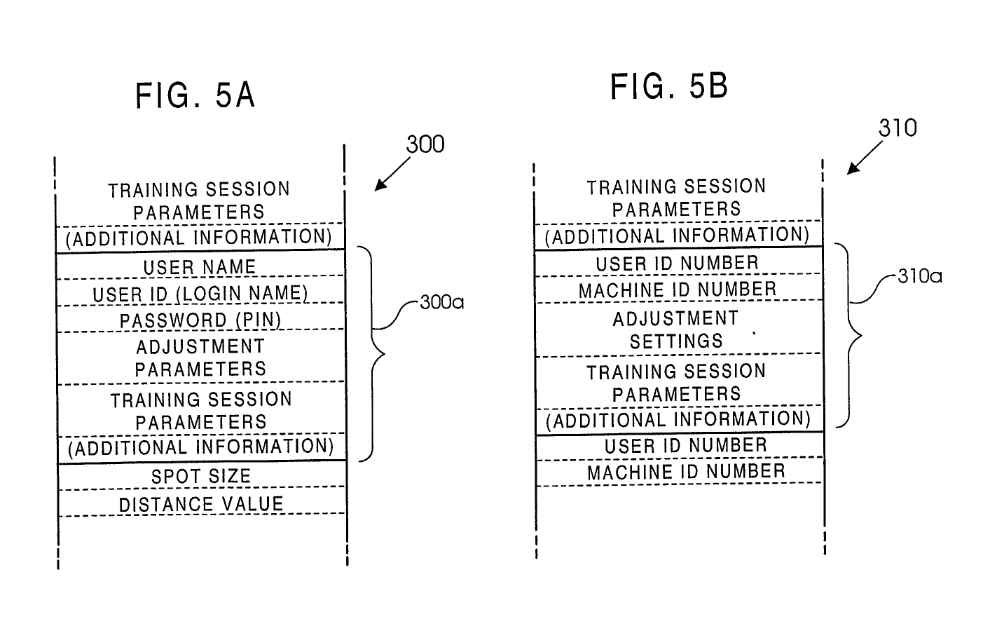

Referring now to FIGS. 5A and 5B, two possible database record formats are provided. In FIG. 5A, a first possible embodiment of a record 300a of a database 300 is depicted. The record may start with an indication of the full name of a user. Next, a user ID or login name and password may be provided. The user ID and password may be formed of any user preferred string of alphanumeric characters. The record 300a may next provide one or more values or settings associated with physical parameters to be applied to the training apparatus or station to adjust and configure the apparatus. Next, training session parameters, such as a repetition count, resistance settings/levels, time intervals, and other possible parameter settings may be downloaded and utilized. If needed, additional information may also be stored within the accessed record, as needed for supporting the operation of the apparatus and for an updating of present records of the user.

Yet another possible record format is provided in FIG. 5B. This format includes user ID information, which may be similar to the user name, user ID, and PIN of FIG. 5A. Next, as can be seen in FIG. 5B, an apparatus type number may be provided to identify which training apparatus the user is about to use. Once a machine ID is matched to a training station to be employed, a plurality adjusting and configuring settings and session parameters, similar to those of FIG. 5A may be available for accessing, downloading, and applying to the apparatus (or a training station thereof). It may be noted that a database 300, and records 300a, may be preferred for training apparatus 10 of FIG. 1, while, a database 310 and records 310a may be preferred for use with the training system 12 of FIG. 3.

It must be understood that the description of the embodiments of the present invention are illustrative only, and other equivalent arrangements are certainly possible. Therefore, while there have been described herein the currently preferred embodiments of a configurable resistance training apparatus, or a distributed embodiment thereof, those skilled in the art will recognize that other and further modifications may be made without departing from the present invention. It is certainly intended to claim all such modifications and variations that fall within the scope of the appended claims.

What is claimed is:

1. A computerized resistance training apparatus structured with a resistance training mechanism enabling a user to perform repetitions of an exercising or training activity useful for conditioning one or more muscles of the user, the resistance training apparatus comprising:
a computer;
an adjustment mechanism, which is responsive to the computer, and operatively coupled to the resistance training mechanism enabling adjusting and configuring of at least one setting of the resistance training apparatus for use by the user;
means to enable a user commencing activities upon the resistance training apparatus to be identified; and
means for enabling at least one personalized setting, which was previously determined, to be recalled by the computer and applied for adjusting and configuring the resistance training mechanism of the apparatus upon an identifying of the user.

2. The resistance training apparatus in accordance with claim 1, wherein the personalized settings are recalled from a database and applied by the computer of the apparatus upon an identifying of the user.

3. The resistance training apparatus in accordance with claim 2, wherein the database is remotely located.

4. The resistance training apparatus in accordance with claim 1, wherein the means to identify the user includes a human interface.

5. The resistance training apparatus in accordance with claim 4, wherein the human interface includes at least one of:
a) a keypad;
b) a magnetic card reader;
c) a bio-scanning means; and
d) a radio frequency identifying means.

6. A computerized and automated resistance training apparatus, comprising:
a resistance training mechanism structured for enabling a user to perform repetitions of an exercising or training activity, the activity having associated therewith a resistance setting that is employed to establish a pre-determined level of resistance to movements of the user, the resistance training mechanism further structured for enabling an adjusting of physical parameters of user contacting portions of the resistance training mechanism to accommodate a respective user commencing activities upon the apparatus;
a computer; and
an adjustment mechanism that is responsive to the computer, and structured for adjusting the physical parameters of the resistance training apparatus by applying personalized settings associated with an identified user.

7. The resistance training apparatus in accordance with claim 6, having means for supporting:
a) an identifying a user;
b) a downloading of personalized settings from a database as a result of identifying the user; and
c) an applying of the personalized settings causing physical parameters of the apparatus to be automatically adjusted with no additional user input.

8. The resistance training apparatus in accordance with claim 7, wherein a process of identifying the user is followed by an authorization check to determine if the user is authorized to use the apparatus at which the user has been identified.

9. The resistance training apparatus in accordance with claim 7, wherein the adjustment mechanism includes at least one of the following devices, each of which is responsive to the computer:
a) motorized actuator;
b) a linear actuator; and
c) a solenoid actuator; each actuator structured and functionally coupled to portions of the training apparatus for adjusting at least one physical parameter and at least one resistance setting to a predetermined personalized setting, as a function of the identified user and associated information retrieved from a database.

10. A distributed, computerized, and automated resistance training system having a plurality of resistance training stations, with each station structured for enabling a user to perform repetitions of a respective resistance training activity, the resistance training system comprising:
a computer;
the plurality of configurable resistance training stations, wherein each station is structured with a resistance training mechanism that is in operative communication with the computer for enabling adjusting and configuring of the resistance training mechanism for use by a respective user upon an identifying of the user;
each resistance training station including means enabling personalized settings of an identified user to be applied for adjusting and configuring the station for use by the identified user.

11. The training system in accordance with claim 10, wherein the means enabling personalized settings to be applied includes:
an adjustment mechanism that is responsive to the computer, and structured for adjusting at least one physical parameters of the training system by applying personalized settings associated with an identified user to a training station;
a human interface for identifying a user; and
a database available for selecting, retrieving and downloading personalized settings, once a user is identified, with downloaded settings applied by the computer causing an adjusting of physical parameters of the apparatus with no additional user input.

12. The training system in accordance with claim 11, wherein a computer and database are remote, with each resistance training station further including a communications interface enabling the personalized setting to be downloaded from the database to a training station that is going to be used by the user.

13. The training system in accordance with claim 12, wherein personalized settings including at least one of:
a) settings to adjust physical dimensions of user contacting portions of the resistance training mechanism to accommodate the user, with adjustments realized by actuating one or more adjusting means of the adjustment mechanism;
b) at least one resistance level setting employed to establish a resistance level for an upcoming resistance training activity; and
c) a repetition count setting for the upcoming resistance training activity.

14. The training system in accordance with claim 13, wherein the personalized settings are altered and updated, and stored back in the database for future use, as a result of at least one of:
a) a completing of a pre-determined number of repetitions of a given training or exercising activity;
b) a number of retrievals of personalized settings from the remote database;
c) adjustments associated with previous user performed station activities; and
d) calculations based on previously stored personalized settings, along with information associated with previous user performed station activities.

15. A method of configuring and using a resistance training apparatus, the method comprising the steps of:
a) identifying a user;
b) accessing and downloading at least one physical parameter previously determined from a database;
c) applying downloaded physical parameters to adjust and configure user contacting portions and resistance settings of the apparatus for use by the identified user; and
d) conducting training activities upon the apparatus after an automated adjusting and configuring of at least one physical parameter and a resistance level.

16. The method in accordance with claim 15, wherein the step of identifying the user includes a login process wherein the user provides a unique identification code during the login process.

17. The method in accordance with claim 16, wherein the database is remote and accessed by way of an interface and a communication network.
